(19) United States
(12) Patent Application Publication
(10) Pub. No.: US 2023/0278556 A1
(43) Pub. Date: Sep. 7, 2023

(54) DRIVER ASSISTANCE SYSTEM AND DRIVER ASSISTANCE METHOD

(71) Applicant: HL KLEMOVE CORP., Incheon (KR)

(72) Inventor: Hyeongtae KIM, Gyeonggi-do (KR)

(21) Appl. No.: 18/115,760

(22) Filed: Feb. 28, 2023

(30) Foreign Application Priority Data
Mar. 2, 2022 (KR) 10-2022-0026892

(51) Int. Cl. B60W 30/12

(52) U.S. Cl. CPC B60W 30/12; B60W 2420/42; B60W 2420/52; B60W 2552/53; B60W 2554/404

(57) ABSTRACT

A driver assistance system includes a camera, a radar, and a controller, wherein the controller may be configured to determine whether a lane line of a driving lane of the vehicle is identified or whether a preceding vehicle positioned in front of the vehicle is identified, depending on a result of the determination, select and perform traveling control of any one of lane line following control of following the identified lane line, vehicle following control of following the identified preceding vehicle, and virtual lane line following control of generating a virtual driving lane line and following the generated virtual driving lane line, and release the traveling control of the vehicle on the basis of an operating time of the virtual lane line following control exceeding a predetermined control limit time while the virtual lane line following control is performed.

### CROSS-REFERENCE TO RELATED APPLICATION

This application claims the benefit of Korean Patent Application No. 10-2022-0026892, filed on Mar. 2, 2022 in the Korean Intellectual Property Office, the disclosure of which is incorporated herein by reference.

### BACKGROUND

### 1. Field

Embodiments of the present disclosure relate to a driver assistance system and a driver assistance method, and more specifically, to a driver assistance system and a driver assistance method, which change a control mode to vehicle following control of following a preceding vehicle or a virtual lane line following control of generating virtual lane lines and following the virtual lane lines depending on surrounding environments when lane lines may not be identified under the lane line following control and perform traveling control.

### 2. Description of the Related Art

A lane following assist system is a driver assistance system and performs steering control of a vehicle by setting a following target, such as a center of a lane or a preceding vehicle, in various traveling situations.

Basically, the lane following assist system intends to follow the center of a lane on the basis of lane line recognition. However, when the following target is limited to lane lines, the system does not operate when it is difficult to identify lane lines due to a poor lane line condition or lane lines are not present, such as an intersection.

Therefore, when it is difficult to identify the lane lines as described above, the availability of the system is increased by setting the preceding vehicle as the following target. At this time, the general lane following assist system is designed so that the lane line as the following target has a higher priority than the preceding vehicle. This is because the preceding vehicle may show movement different from a target route of an actual host vehicle.

However, as described above, even in the system having a higher availability by setting the preceding vehicle as the following target, a situation in which control is stopped may occur when the preceding vehicle is not present.

### SUMMARY

Therefore, it is an aspect of the present disclosure to provide a driver assistance system and a driver assistance method, which change a control mode to perform traveling control under vehicle following control of following a preceding vehicle or a virtual lane line following control of generating virtual lane lines and following the virtual lane lines depending on surrounding environments when lane lines may not be identified under the lane line following control.

Additional aspects of the disclosure will be set forth in part in the description which follows and, in part, will be obvious from the description, or may be learned by practice of the disclosure.

In accordance with one aspect of the present disclosure, a driver assistance system includes a camera configured to acquire image data of surroundings of a vehicle with a field of view around the vehicle, a radar configured to acquire radar data of the surroundings of the vehicle with a field of sensing around the vehicle, and a controller electrically connected to the camera and the radar to perform traveling control of the vehicle, wherein the controller may be configured to determine whether a lane line of a driving lane of the vehicle is identified or whether a preceding vehicle positioned in front of the vehicle is identified on the basis of the image data of the surroundings of the vehicle or the radar data of the surroundings of the vehicle, depending on a result of the determination, select and perform traveling control of any one of lane line following control of following the identified lane line, vehicle following control of following the identified preceding vehicle, and virtual lane line following control of generating a virtual driving lane line and following the generated virtual driving lane line, and release the traveling control of the vehicle on the basis of an operating time of the virtual lane line following control exceeding a predetermined control limit time while the virtual lane line following control is performed.

The controller may be configured to, based on the lane line of the driving lane being identifiable on the basis of the image data of the surroundings of the vehicle, perform the lane line following control of determining a target trajectory of the vehicle on the basis of the lane line and controlling the vehicle to travel, based on the lane line being not identifiable, perform the vehicle following control of identifying the preceding vehicle positioned in front of the vehicle on the basis of the radar data of the surroundings of the vehicle, determining a target trajectory of the vehicle on the basis of a traveling route of the preceding vehicle, and controlling the vehicle to travel, and based on the preceding vehicle being not identifiable, perform the virtual lane line following control of generating the virtual driving lane line on the basis of a lane line of a last identified driving lane, determining a target trajectory of the vehicle on the basis of the virtual driving lane line, and controlling the vehicle to travel.

The controller may be configured to check whether the lane line of the driving lane of the vehicle is identifiable on the basis of the image data of the surroundings of the vehicle while the vehicle following control or the virtual lane line following control is performed, and based on the lane line being identifiable, terminate the vehicle following control or the virtual lane line following control being performed, and perform the lane line following control.

The controller may be configured to release the traveling control of the vehicle on the basis of the preceding vehicle being not identifiable in front of the vehicle while the vehicle following control is performed.

The controller may be configured to check whether the preceding vehicle positioned in front of the vehicle is identified while the virtual lane line following control is performed, terminate the virtual lane line following control being performed when identifying the preceding vehicle, and perform the vehicle following control.

The controller may be configured to follow corrected lane lines generated on the basis of positions of left and right lane lines, heading angles of the left and right lane lines, curvatures of the left and right lane lines, and changes in the curvatures of the left and right lane lines on the basis of the identified lane line of the driving lane of the vehicle being not suitable for following when the lane line following control is performed.

The corrected lane lines may be generated on the basis of Equations 1 and 2,

yₗ=αₗx³+bₗx²+cₗx+dₗ (Equation 1)

yᵣ=αᵣx³+bᵣx²+cᵣx+dᵣ (Equation 2)

(yₗ and yᵣ denote positions of the left and right corrected lane lines at an x position, respectively, αₗ and αᵣ denote the changes in the curvatures of the left and right lane lines, respectively, bₗ and bᵣ denote the curvatures of the left and right lane lines, respectively, cₗ and cᵣ denote the heading angles of the left and right lane lines, respectively, and dₗ and dᵣ denote the positions of the left and right lane lines, respectively).

The controller may generate the virtual driving lane line on the basis of positions of last identified left and right lane lines, heading angles of the left and right lane lines, curvatures of the left and right lane lines, a yaw rate of the vehicle, and a vehicle speed of the vehicle when the virtual lane line following control is performed.

The virtual driving lane line may be generated on the basis of Equations 3 and 4,

y_{l,v}=b_{l,0}x²+(c_{l,0}−∫ωΨ′)x+d_{l,0}+∫∫vₓΨ′ (Equation 3)

y_{r,v}=b_{r,0}x²+(c_{r,0}−∫Ψ′)x+d_{r,0}+∫∫vₓΨ′ (Equation 4)

(y_{l,v} and y_{r,v} denote positions of the left and right virtual driving lane lines at the x position, respectively, b_{l,0} and b_{r,0} denote the curvatures of the last identified left and right lane lines, respectively, c_{l,0} and c_{r,0} denote the heading angles of the last identified left and right lane lines, respectively, d_{l,0} and d_{r,0} denote the positions of the last identified left and right lane lines, respectively, P denotes the yaw rate of the vehicle, and vₓ, denotes the vehicle speed of the vehicle).

In accordance with another aspect of the present disclosure, a driver assistance method includes acquiring image data of surroundings of a vehicle or radar data of the surroundings, determining whether a lane line of a driving lane of the vehicle is identified or whether a preceding vehicle positioned in front of the vehicle is identified on the basis of the acquired image data of the surroundings or the acquired radar data of the surroundings, and depending on a result of the determination, selecting and performing traveling control of any one of lane line following control of following the identified lane line, vehicle following control of following the identified preceding vehicle, and virtual lane line following control of generating a virtual driving lane line and following the generated virtual driving lane line, wherein the performing of the virtual lane line following control may include releasing the traveling control of the vehicle on the basis of an operating time of the virtual lane line following control exceeding a predetermined control limit time while the virtual lane line following control is performed.

The selecting and performing of the traveling control may include based on the lane line of the driving lane being identifiable on the basis of the image data of the surroundings of the vehicle, performing the lane line following control of determining a target trajectory of the vehicle on the basis of the lane line and controlling the vehicle to travel, based on the lane line being not identifiable, performing the vehicle following control of identifying the preceding vehicle positioned in front of the vehicle on the basis of the radar data of the surroundings of the vehicle, determining a target trajectory of the vehicle on the basis of a traveling route of the preceding vehicle, and controlling the vehicle to travel, and based on the preceding vehicle being not identifiable, performing the virtual lane line following control of generating the virtual driving lane line on the basis of a last identified lane line of the driving lane, determining a target trajectory of the vehicle on the basis of the virtual driving lane line, and controlling the vehicle to travel.

The performing of the vehicle following control or the performing of the virtual lane line following control may include checking whether the lane line of the driving lane of the vehicle is identifiable on the basis of the image data of the surroundings of the vehicle while the vehicle following control or the virtual lane line following control is performed, and based on the lane line being identifiable, terminating the vehicle following control or the virtual lane line following control being performed, and performing the lane line following control.

The performing of the vehicle following control may include releasing the traveling control of the vehicle on the basis of the preceding vehicle being not identifiable in front of the vehicle while the vehicle following control is performed.

The performing of the virtual lane line following control may include checking whether the preceding vehicle positioned in front of the vehicle is identifiable while the virtual lane line following control is performed, and based on the preceding vehicle being identifiable, terminating the virtual lane line following control being performed, and performing the vehicle following control.

The performing the lane line following control may include following corrected lane lines generated on the basis of positions of left and right lane lines, heading angles of the left and right lane lines, curvatures of the left and right lane lines, and changes in the curvatures of the left and right lane lines on the basis of the identified lane line of the driving lane of the vehicle being not suitable for following when the lane line following control is performed.

The corrected lane lines may be generated on the basis of Equations 1 and 2,

yₗ=αₗx³+bₗx²+cₗx+dₗ (Equation 1)

yᵣ=αᵣx³+bᵣx²+cᵣx+dᵣ (Equation 2)

(yₗ and yᵣ denote positions of the left and right corrected lane lines at an x position, respectively, αₗ and αᵣ denote the changes in the curvatures of the left and right lane lines, respectively, bₗ and bᵣ denote the curvatures of the left and right lane lines, respectively, cₗ and cᵣ denote the heading angles of the left and right lane lines, respectively, and dₗ and dᵣ denote the positions of the left and right lane lines, respectively).

The performing of the virtual lane line following control may include generating the virtual driving lane line on the basis of positions of last identified left and right lane lines, heading angles of the left and right lane lines, curvatures of the left and right lane lines, a yaw rate of the vehicle, and a vehicle speed of the vehicle when the virtual lane line following control is performed.

The virtual driving lane line may be generated on the basis of Equations 3 and 4,

y_{l,v}=b_{l,0}x²+(c_{l,0}−∫ωΨ′)x+d_{l,0}+∫∫vₓΨ′ (Equation 3)

y_{r,v}=b_{r,0}x²+(c_{r,0}−∫Ψ′)x+d_{r,0}+∫∫vₓΨ′ (Equation 4)

(y_{l,v} and y_{r,v} denote positions of the left and right virtual driving lane lines at the x position, respectively, b_{l,0} and b_{r,0} denote the curvatures of the last identified left and right lane lines, respectively, c_{l,0} and c_{r,0} denote the heading angles of the last identified left and right lane lines, respectively, d_{l,0} and d_{r,0} denote the positions of the last identified left and right lane lines, respectively, Ψ denotes the yaw rate of the vehicle, and vₓ denotes the vehicle speed of the vehicle).

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a control block diagram of a driver assistance system according to an embodiment;

FIG. 2 is a view schematically showing a camera and radar of the driver assistance system according to the embodiment;

FIG. 3 is a mode switching diagram of a controller of the driver assistance system according to the embodiment;

FIG. 4 is a view schematically showing a state of lane line following control of the driver assistance system according to the embodiment;

FIG. 5 is a view schematically showing a state of vehicle following control of the driver assistance system according to the embodiment;

FIG. 6 is a view schematically showing a state of virtual lane line following control of the driver assistance system according to the embodiment;

FIG. 7 is a control flowchart of the driver assistance method according to the embodiment;

FIG. 8 is a view schematically showing a method of generating corrected lane lines of the driver assistance system according to the embodiment; and

FIG. 9 is a view schematically showing a method of generating virtual lane lines of the driver assistance system according to the embodiment.

### DETAILED DESCRIPTION

The same reference numbers indicate the same components throughout the specification. The specification does not describe all elements of embodiments, and general contents or overlapping contents between the embodiments in the technical field to which the disclosure pertains will be omitted. Terms “unit, module, member, and block” used in the specification may be implemented as software or hardware, and according to the embodiments, a plurality of “units, modules, members, and blocks” may be implemented as one component or one “unit, module, member, and block” may also include a plurality of components.

Throughout the specification, when a certain portion is described as being “connected” to another, this includes not only a case of being directly connected thereto but also a case of being indirectly connected thereto, and the indirect connection includes connection through a wireless communication network.

In addition, when a certain portion is described as “including,” a certain component, this means further including other components rather than precluding other components unless especially stated otherwise.

Throughout the specification, when a certain member is described as being positioned “on” another, this includes not only a case where the certain member is in contact with another but also a case where other members are present between the two members.

Terms such as first and second are used to distinguish one component from another, and the components are not limited by the above-described terms. A singular expression includes plural expressions unless the context clearly dictates otherwise.

In each operation, identification symbols are used for convenience of description, and the identification symbols do not describe the sequence of each operation, and each operation may be performed in a different sequence from the specified sequence unless a specific sequence is clearly described in context.

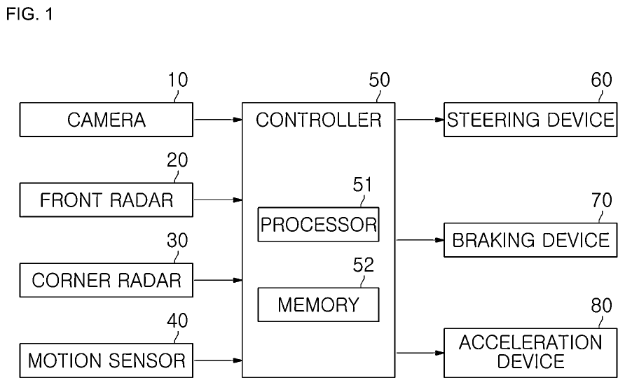

FIG. 1 is a control block diagram of a driver assistance system according to an embodiment.

Referring to FIG. 1, the driver assistance system may include a camera 10, a front radar 20, a corner radar 30, a motion sensor 40, and a controller 50.

The controller 50 may perform overall control of the driver assistance system.

The camera 10, the front radar 20, the corner radar 30, and the motion sensor may be electrically connected to the controller 50.

The controller 50 may control a steering device 60, a braking device 70, and an acceleration device 80. In addition, the controller 50 may be electrically connected to other electronic devices of a vehicle.

Each of the camera 10, the front radar 20, the corner radar 30, and the motion sensor 40 may include an electronic control unit (ECU). The controller 50 may also be implemented as an integrated controller including a controller of the camera 10, a controller of the front radar 20, a controller of the corner radar 30, and a controller of the motion sensor 40.

The camera 10 may capture the vehicle's surroundings, particularly, a forward view of the vehicle, and identify other vehicles, pedestrians, cyclists, lane lines, road signs, and the like. In addition, the camera 10 may identify road structures such as a median strip and a guard rail.

The camera 10 may include a plurality of lenses and an image sensor. The image sensor may include a plurality of photodiodes for converting light into electrical signals, and the plurality of photodiodes may be disposed in the form of a two-dimensional matrix.

The camera 10 may be electrically connected to the controller 50. For example, the camera 10 may be connected to the controller 50 via a vehicle communication network NT, connected to the controller 50 via a hard wire, or connected to the controller 50 via a printed circuit board (PCB).

The camera 10 may transmit image data around the vehicle to the controller 50.

A radar including the front radar 20 and the corner radar 30 may acquire relative positions, relative speeds, and the like of objects (e.g., other vehicles, pedestrians, and cyclists) around the vehicle.

The front radar 20 and the corner radar 30 may be connected to the controller 50 via a vehicle communication network NT, a hard wire, or a PCB.

The front radar 20 and the corner radar 30 may transmit radar data around the vehicle to the controller 50. These radars may also be implemented as a light detection and ranging (LiDAR) device.

The motion sensor 40 may acquire motion data of the vehicle. For example, the motion sensor 40 may include a speed sensor for detecting a speed of a wheel, an acceleration sensor for detecting lateral acceleration and longitudinal acceleration of the vehicle, a yaw rate sensor for detecting a change in angular velocity of the vehicle, a gyro sensor for detecting an inclination of the vehicle, a steering angle sensor for detecting rotation and a steering angle of a steering wheel, and/or a torque sensor for detecting a steering torque of the steering wheel. The motion data may include a vehicle speed, longitudinal acceleration, lateral acceleration, a steering angle, a steering torque, a traveling direction, a yaw rate, and/or an inclination.

The steering device 60 may change a traveling direction of the vehicle under the control of the controller 50.

The braking device 70 may decelerate the vehicle by braking wheels of the vehicle under the control of the controller 50.

The acceleration device 80 may accelerate the vehicle by driving an engine and/or a driving motor for providing a driving force to the vehicle under the control of the controller 50.

The controller 50 may include a processor 51 and a memory 52.

The controller 50 may include one or more processors 51. The one or more processors 51 included in the controller 50 may be integrated into one chip or may also be physically separated. In addition, the processor 51 and the memory 52 may also be implemented as a single chip.

The processor 51 may process the image data of the camera 10, front radar data of the front radar 20, and corner radar data of the corner radar 30. In addition, the processor 51 may generate a steering signal for controlling the steering device 60, a braking signal for controlling the braking device 70, and an acceleration signal for controlling the acceleration device 80.

For example, the processor 51 may include an image signal processor for processing the image data of the camera 10, a digital signal processor for processing the radar data of the radars 20 and 30, and the MCU for generating the steering signal, the braking signal, and the acceleration signal.

The memory 52 may store a program and/or data for the processor 51 to process the image data. The memory 52 may store a program and/or data for the processor 51 to process the radar data. In addition, the memory 52 may store a program and/or data for the processor 51 to generate control signals related to a configuration of the vehicle.

The memory 52 may temporarily store the image data received from the camera 10 and/or the radar data received from the radars 20 and 30. In addition, the memory 52 may temporarily store a result of processing the image data and/or the radar data by the processor 51. The memory 52 may include not only volatile memories such as a static random access memory (SRAM) and a dynamic random access memory (DRAM), but also non-volatile memories such as flash memory, read only memory (ROM), and erasable programmable ROM (EPROM).

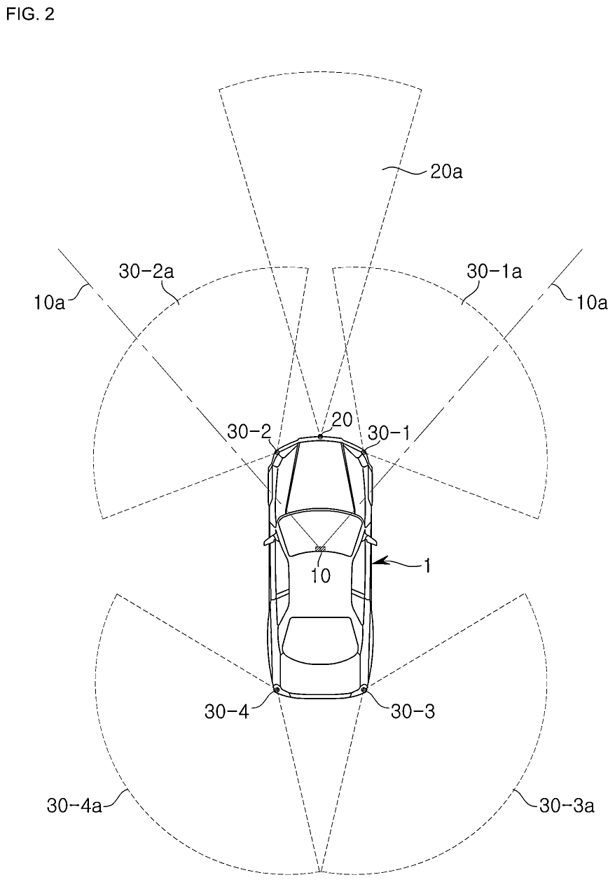

FIG. 2 is a view schematically showing a camera and radar of the driver assistance system according to the embodiment.

Referring to FIG. 2, the camera 10 may have a field of view 10a around the vehicle 1, particularly, a forward view of the vehicle 1. For example, the camera 10 may be installed on a front windshield of the vehicle 1. The camera 10 may capture images of surroundings of the vehicle 1 and acquire image data of the surroundings of the vehicle 1. The image data of the surroundings of the vehicle 1 may include position information on other vehicles, pedestrians, cyclists, lane lines, and intersection structures (a median strip, a guard rail, and the like) positioned around the vehicle 1.

The front radar 20 may have a field of sensing 20a forward from the vehicle 1. The front radar 20 may be installed on, for example, a grille or a bumper of the vehicle 1.

The front radar 20 may include a transmission antenna (or a transmission antenna array) for radiating transmitted radio waves forward from the vehicle 1 and a reception antenna (or a reception antenna array) for receiving radio waves reflected from objects. The front radar 20 may acquire front radar data from the transmitted radio wave transmitted by the transmission antenna and the reflected radio wave received by the reception antenna.

The front radar data may include distance information and speed information of other vehicles, pedestrians, and cyclists positioned in front of the vehicle 1. In addition, the front radar data may include distance information on intersection structures, such as a median strip and a guard rail, positioned in front of the vehicle 1.

The front radar 20 may calculate a relative distance to the object on the basis of a phase difference (or a time difference) between the transmitted radio wave and the reflected radio wave and calculate a relative speed of the object on the basis of a frequency difference between the transmitted radio wave and the reflected radio wave.

The corner radar 30 may include a first corner radar 30-1 installed on a front right side of the vehicle 1, a second corner radar 30-2 installed on a front left side of the vehicle 1, a third corner radar 30-3 installed on a rear right side of the vehicle 1, and a fourth corner radar 30-4 installed on a rear left side of the vehicle 1.

The first corner radar 30-1 may have a field of detection 30-1a toward the front right of the vehicle 1. The second corner radar 30-2 may have a field of sensing 30-2a toward the front left of the vehicle 1, the third corner radar 30-3 may have a field of sensing 30-3a toward the rear right of the vehicle 1, and the fourth corner radar 30-4 may have a field of sensing 30-4a toward the rear left of the vehicle 1.

Each of the corner radars 30 may include the transmission antenna and the reception antenna. The first, second, third, and fourth corner radars 30-1, 30-2, 30-3, and 30-4 respectively acquire first corner radar data, second corner radar data, third corner radar data, and fourth corner radar data. The first corner radar data may include distance information and speed information of an object positioned at the front right side of the vehicle 1. The second corner radar data may include distance information and speed information of an object positioned at the front left side of the vehicle 1. The third and fourth corner radar data may include distance information and speed information of objects positioned at the rear right side of the vehicle 1 and the rear left side of the vehicle 1.

Referring back to FIG. 2, the controller 50 may detect and/or identify objects in front of the vehicle 1 on the basis of the image data of the surroundings of the camera 10 and the radar data of the surroundings of the front radar 20 and the corner radar 30 and acquire position information (distances and directions) and speed information (relative speeds) of objects in front of the vehicle 1. In addition, the processor 51 may acquire the position information (distances and directions) and the speed information (relative speeds) of the objects around the vehicle 1 (positioned at the front, front right, front left, rear right, and rear left of the vehicle 1) on the basis of the front radar data and the corner radar data of the front radar 20 and the plurality of corner radars 30.

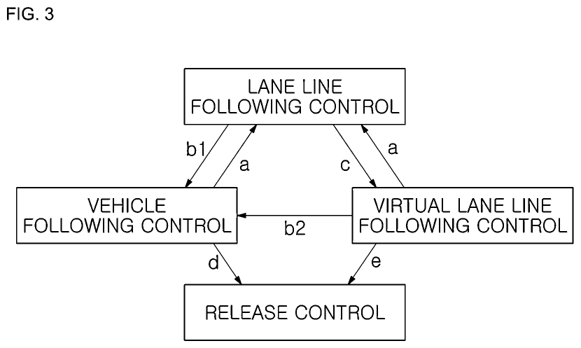

FIG. 3 is a mode switching diagram of a controller of the driver assistance system according to the embodiment.

Referring to FIG. 3, the controller 50 of the driver assistance system according to the present disclosure may select and perform a traveling control mode of any one of lane line following control of following an identified lane line, vehicle following control of following an identified preceding vehicle 2, or virtual lane line following control of generating virtual driving lane lines 5L and 5R and following the generated virtual driving lane lines 5L and 5R.

The controller 50 determines whether lane lines LL and RL of a driving lane DL of the vehicle 1 are identified or whether the preceding vehicle 2 positioned in front of the vehicle 1 is identified on the basis of the image data of the surroundings of the vehicle 1 or the radar data of the surroundings of the vehicle 1 and selects and performs the traveling control of any one of the lane line following control, the vehicle following control, or the virtual lane line following control depending on the determination result.

When the controller 50 may identify the lane lines LL and RL of the driving lane DL of the vehicle 1 on the basis of the image data of the surroundings of the vehicle 1, the controller 50 performs the lane line following control of determining a target trajectory of the vehicle 1 on the basis of the lane lines LL and RL and controlling the vehicle 1 to travel.

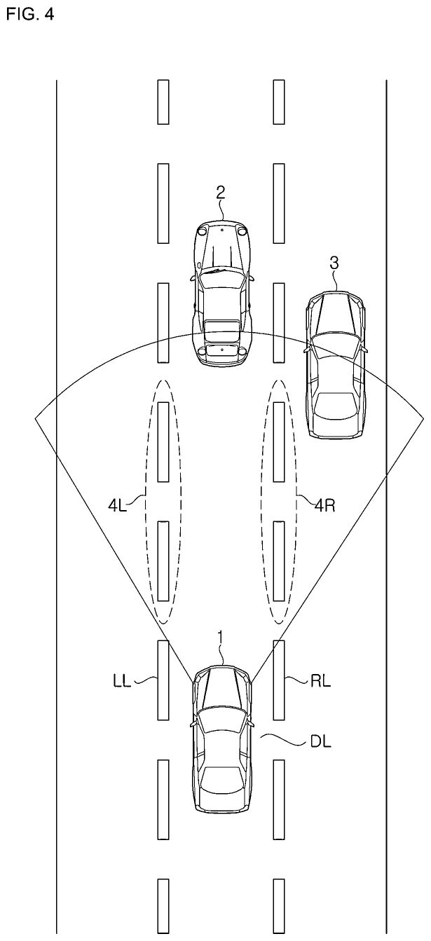

FIG. 4 is a view schematically showing a state of lane line following control of the driver assistance system according to the embodiment.

The controller 50 acquires the image data of the surroundings of the vehicle 1 from the camera 10 and identifies the lane lines LL and RL of the driving lane DL of the vehicle 1 on the basis of the image data of the surroundings of the vehicle 1. FIG. 4 shows a forward field of view of the camera 10. As shown in FIG. 4, when the left and right lane lines LL and RL of the driving lane DL of the vehicle 1 may each be detected and identified 4L and 4R within the forward field of view of the camera 10, the controller 50 determines the target trajectory of the vehicle 1 on the basis of the identified lane lines LL and RL and controls the traveling.

Meanwhile, when the lane lines LL and RL may not be identified, the controller 50 performs the vehicle following control of identifying the preceding vehicle 2 positioned in front of the vehicle 1 on the basis of the radar data of the surroundings of the vehicle 1, determining the target trajectory of the vehicle 1 on the basis of a traveling route of the preceding vehicle 2, and controlling the vehicle 1 to travel.

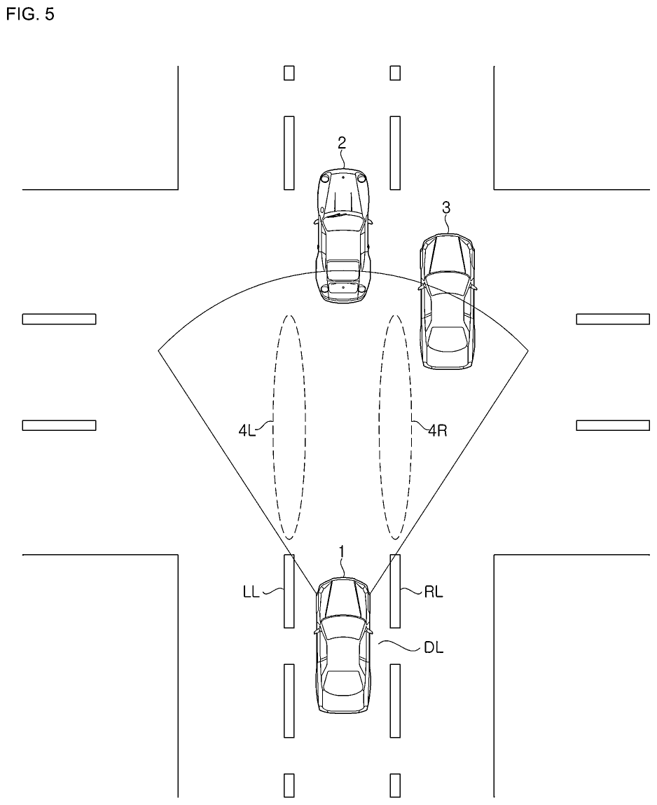

FIG. 5 is a view schematically showing a state of vehicle following control of the driver assistance system according to the embodiment.

When the controller 50 may not identify the lane lines LL and RL, the controller 50 acquires the radar data of the surroundings of the vehicle 1 from the radars 20 and 30, particularly, the front radar 20 and identifies the preceding vehicle 2 positioned in front of the vehicle 1 on the basis of the radar data of the surroundings of the vehicle 1. FIG. 5 shows the forward field of view of the camera 10. As shown in FIG. 5, when the left and right lane lines LL and RL of the driving lane DL of the vehicle 1 are not identified 4L and 4R within the forward field of view of the camera 10, for example, when the left and right lane lines LL and RL, such as the intersection shown in FIG. 5, are not present, the target trajectory of the vehicle 1 may not be determined on the basis of the lane lines LL and RL. Therefore, the controller 50 identifies the preceding vehicle 2 positioned in front of the vehicle 1 on the basis of the radar data of the surroundings of the vehicle 1. Here, the preceding vehicle 2 means a target vehicle positioned in front of the vehicle 1 and suitable for following.

Referring to FIG. 5, two other vehicles 2 and 3 are positioned in front of the vehicle 1. In one embodiment, the controller 50 may identify the vehicle 2 determined to be positioned on the same lane as the driving lane DL of the vehicle 1 as the preceding vehicle 2. When the controller 50 identifies the preceding vehicle 2, the controller 50 determines the target trajectory of the vehicle 1 on the basis of the traveling route of the preceding vehicle 2 and controls the traveling of the vehicle 1.

Meanwhile, when the controller 50 may not identify the preceding vehicle 2, the controller 50 performs the virtual lane line following control of generating the virtual driving lane lines 5L and 5R on the basis of last identified lane lines LL and RL of the driving lane DL, determining the target trajectory of the vehicle 1 on the basis of the virtual driving lane lines 5L and 5R, and controlling the vehicle 1 to travel.

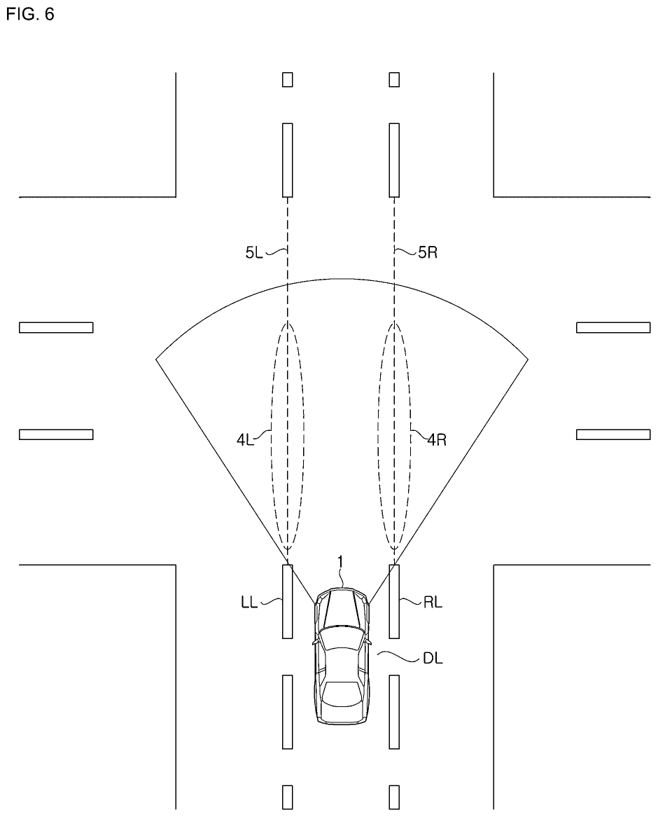

FIG. 6 is a view schematically showing a state of virtual lane line following control of the driver assistance system according to the embodiment.

When the controller 50 may not identify the lane lines LL and RL and the preceding vehicle 2, the controller 50 generates the virtual driving lane lines 5L and 5R on the basis of the last identified lane lines LL and RL of the driving lane DL. FIG. 6 shows the forward field of view of the camera 10. When the left and right lane lines LL and RL of the driving lane DL of the vehicle 1 are not identified 4L and 4R within the forward field of view of the camera 10 and the preceding vehicle 2 may not be identified in front of the vehicle 1 as shown in FIG. 6, the target trajectory of the vehicle 1 may be determined on the lane lines LL and RL, or the target trajectory may not be determined on the basis of the traveling route of the preceding vehicle 2. Therefore, the controller 50 generates the virtual driving lane lines 5L and 5R on the basis of the last identified lane lines LL and RL of the driving lane DL. Referring to FIG. 6, although the left and right lane lines LL and RL of the driving lane DL are not identified in the current forward field of view of the camera 10, the controller 50 may generate the virtual driving lane lines 5L and 5R using information on the last identified left and right lane lines LL and RL. Since the virtual driving lane lines 5L and 5R are generated on the basis of the last identified left and right lane lines LL and RL, the virtual driving lane lines 5L and 5R may be different from actual left and right boundaries of the driving lane DL, but may be generated at positions similar to those of the actual left and right boundaries of the driving lane DL for a predetermined time. As described above, when the virtual driving lane lines 5L and 5R are generated, the controller 50 determines the target trajectory of the vehicle 1 on the basis of the generated virtual driving lane lines 5L and 5R and controls the traveling of the vehicle 1.

As described above, the controller 50 may determine whether the lane lines LL and RL of the driving lane DL of the vehicle 1 are identified or whether the preceding vehicle 2 positioned in front of the vehicle 1 is identified and select the traveling control mode depending on the determination result.

However, the controller 50 may select the traveling control mode differently depending on the traveling control mode currently being executed as well as the determination result of the controller 50.

Referring back to FIG. 3, the controller 50 may check whether the lane lines LL and RL of the driving lane DL of the vehicle 1 are identified on the basis of the image data of the surroundings of the vehicle 1 while the vehicle following control or the virtual lane line following control is performed, terminate the vehicle following control or the virtual lane line following control being performed when the lane lines LL and RL may be identified, and perform the lane line following control. This is indicated by a in FIG. 3.

As described above, the vehicle following control or the virtual lane line following control is performed when the lane lines LL and RL of the driving lane DL of the vehicle 1 may not be identified. As described above, even when the vehicle following control or the virtual lane line following control is being performed because the lane lines LL and RL of the driving lane DL of the vehicle 1 may not be identified, the controller 50 continuously checks whether the lane lines LL and RL of the driving lane DL of the vehicle 1 may be identified on the basis of the image data of the surroundings of the vehicle 1, terminates the vehicle following control or the virtual lane line following control being performed when the lane lines LL and RL may be re-identified, and performs the lane line following control. Compared to the vehicle following control of following the preceding vehicle 2 arbitrarily traveled by a driver or the virtual lane line following control of following the virtual driving lane lines 5L and 5R generated by past information, the lane line following control of following the lane lines LL and RL of the actual road may allow the vehicle 1 to travel more stably. Therefore, the controller 50 continuously checks whether the lane lines LL and RL of the driving lane DL of the vehicle 1 may be identified even when the vehicle following control or the virtual lane line following control is being performed and preferentially returns to the lane line following control when the lane lines LL and RL of the driving lane DL of the vehicle 1 may be identified.

Meanwhile, the controller 50 may check whether the lane lines LL and RL of the driving lane DL of the vehicle 1 may be identified on the basis of the image data of the surroundings of the vehicle 1 while the lane line following control is performed, terminate the lane line following control being performed when the lane lines LL and RL may not be identified, and perform the vehicle following control or the virtual lane line following control. When the controller 50 may not identify the lane lines LL and RL, the controller 50 may check whether the preceding vehicle 2 positioned in front of the vehicle 1 may be identified, perform the vehicle following control when the preceding vehicle 2 may be identified, and perform the virtual lane line following control when the preceding vehicle 2 may not be identified. These are respectively indicated by b1 and c in FIG. 3.

Meanwhile, the controller 50 may check whether the preceding vehicle 2 positioned in front of the vehicle 1 may be identified while the virtual lane line following control is performed, terminate the virtual lane line following control being performed when the preceding vehicle 2 may be identified, and perform the vehicle following control. This is indicated by b2 in FIG. 3.

In other words, the controller 50 continuously checks whether the preceding vehicle 2 positioned in front of the vehicle 1 may be identified even when the virtual lane line following control is being performed and preferentially switch to the vehicle following control when the preceding vehicle 2 may be identified. Since an error between the virtual driving lane lines 5L and 5R generated by the past information and the last identified lane lines LL and RL of the driving lane gradually increases over time, it is not possible to ensure traveling stability. Therefore, even when the virtual lane line following control is being performed, the controller 50 continuously checks whether the preceding vehicle 2 may be identified and performs the vehicle following control which is relatively stable when the preceding vehicle 2 may be identified, thereby securing traveling stability.

Conversely, there is no case of switching from the vehicle following control to the virtual lane line following control. The vehicle following control is performed when the lane lines LL and RL of the driving lane DL of the vehicle 1 may not be identified. Therefore, since the vehicle following control is performed after a predetermined time has elapsed since the lane lines LL and RL could not be identified, an error between the virtual driving lane lines 5L and 5R generated on the basis of the last identified lane lines LL and RL of the driving lane and the actual left and right boundaries of the driving lane DL is inevitably large. Therefore, the virtual lane line following control is performed only when the lane lines LL and RL of the driving lane DL of the vehicle 1 may not be identified and the preceding vehicle 2 may not be identified while the lane line following mode is being performed, and there is no switching from the vehicle following control to the virtual lane line following control.

Meanwhile, the controller 50 may release the traveling control of the vehicle when the preceding vehicle 2 positioned in front of the vehicle 1 may not be identified while the controller 50 performs the vehicle following control. This is indicated by d in FIG. 3.

When performing the vehicle following control, the controller 50 identifies the preceding vehicle 2 positioned in front of the vehicle 1, determines the target trajectory of the vehicle 1 on the basis of the traveling route of the preceding vehicle 2, and controls the traveling of the vehicle 1. At this time, when the preceding vehicle 2 may not be identified, the controller 50 may not control the traveling of the vehicle 1 because the controller may not determine the target trajectory. Therefore, when the controller 50 may not identify the preceding vehicle 2 while the vehicle following control is performed, the controller 50 releases the traveling control of the vehicle.

Meanwhile, the controller 50 may release the traveling control of the vehicle when a duration of the virtual lane line following control exceeds a predetermined control limit time while the controller 50 performs the virtual lane line following control. This is indicated by e in FIG. 3.

When the controller 50 performs the virtual lane line following control, the controller 50 generates the virtual driving lane lines 5L and 5R on the basis of the last identified left and right lane lines LL and RL, determines the target trajectory of the vehicle 1 on the basis of the virtual driving lane lines 5L and 5R, and controls the traveling of the vehicle 1. At this time, when the duration of the virtual lane line following control becomes longer, a difference between information of the last identified left and right lane lines LL and RL for generating the virtual driving lane lines 5L and 5R and the left and right boundaries of the current driving lane DL increases. In other words, since the difference between the generated virtual driving lane lines 5L and 5R and the actual driving lane DL increases, the possibility that the vehicle 1 travels along an incorrect target trajectory increases. Therefore, the controller 50 releases the traveling control of the vehicle when the duration of the virtual lane line following control exceeds the predetermined control limit time.

Here, the predetermined control limit time is preferably a time for which the vehicle 1 may pass an intersection by generating the virtual driving lane lines 5L and 5R even when the preceding vehicle 2 is not present and the vehicle 1 passes the intersection or the like that the lane lines LL and RL of the driving lane DL of the vehicle 1 may not be identified.

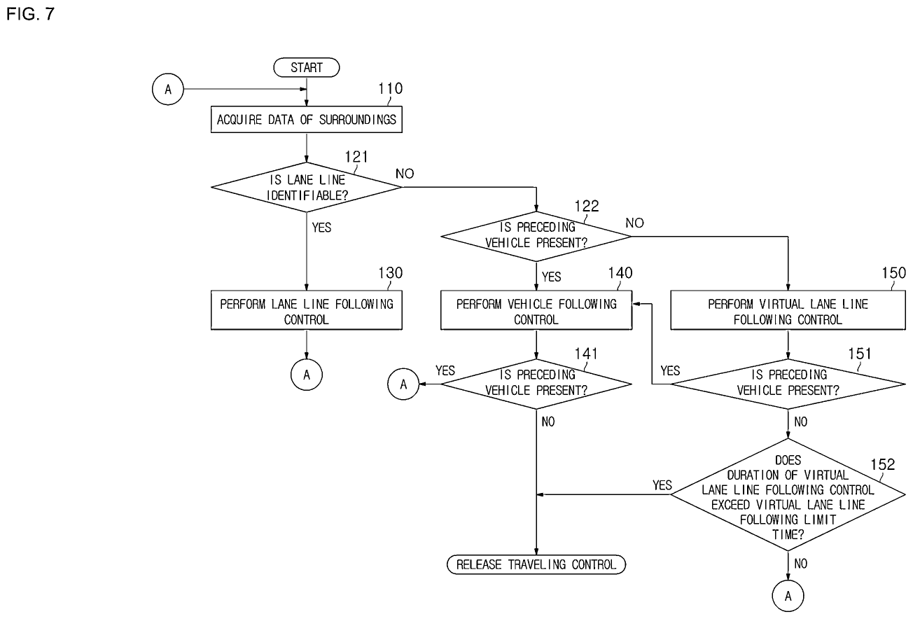

FIG. 7 is a control flowchart of the driver assistance method according to the embodiment.

Referring to FIG. 7, the controller 50 acquires the image data of the surroundings acquired by the camera 10 and the radar data of the surroundings acquired by the radars 20 and 30 (110).

The controller 50 determines whether the lane lines LL and RL of the driving lane DL of the vehicle 1 are identified on the basis of the image data of the surroundings of the vehicle 1 (121).

When the lane lines LL and RL of the driving lane DL of the vehicle 1 may be identified (Yes in 121), the controller 50 performs the lane line following control of following the identified lane lines LL and RL. The controller 50 continuously acquires the image data of the surroundings acquired by the camera 10 and the radar data of the surroundings acquired by the radars 20 and 30 even while performing the lane line following control (A) and continuously determines whether the lane lines LL and RL of the driving lane DL of the vehicle 1 are identified on the basis of the image data of the surroundings of the vehicle 1. Depending on the determination result, the controller 50 may maintain the lane line following control or also change the lane line following control to the vehicle following control or the virtual lane line following control.

Meanwhile, when the lane lines LL and RL of the driving lane DL of the vehicle 1 may not be identified (No in 121), the controller 50 determines whether the preceding vehicle 2 positioned in front of the vehicle 1 is identified on the basis of the radar data of the surroundings of the vehicle 1 (122).

When the controller 50 may identify the preceding vehicle 2 positioned in front of the vehicle 1 (Yes in 122), the controller 50 performs the vehicle following control of following the identified preceding vehicle 2 (140).

The controller 50 continuously determines whether the preceding vehicle 2 positioned in front of the vehicle 1 is identified on the basis of the radar data of the surroundings of the vehicle 1 even while performing the vehicle following control (141).

When the controller 50 may not identify the preceding vehicle 2 while performing the vehicle following control (No in 141), the controller 50 releases the traveling control of the vehicle.

When the controller 50 may identify the preceding vehicle 2 while performing the vehicle following control (Yes in 141), the controller 50 continuously acquires the image data of the surroundings acquired by the camera 10 and the radar data of the surroundings acquired by the radars 20 and 30 (A) and continuously determines whether the lane lines LL and RL of the driving lane DL of the vehicle 1 are identified on the basis of the image data of the surroundings of the vehicle 1. Depending on the determination result, the controller 50 may maintain the vehicle following control or also change the vehicle following control to the lane line following control or the virtual lane line following control.

Meanwhile, when the preceding vehicle 2 positioned in front of the vehicle 1 may not be identified (No in 122), the controller 50 performs the virtual lane line following control of generating the virtual driving lane lines 5L and 5R and following the generated virtual driving lane lines 5L and 5R (150).

The controller 50 continuously determines whether the preceding vehicle 2 positioned in front of the vehicle 1 is identified on the basis of the radar data of the surroundings of the vehicle 1 even while performing the virtual lane line following control (151).

When the controller 50 may identify the preceding vehicle 2 while performing the virtual lane line following control (Yes in 151), the controller 50 performs the vehicle following control of following the identified preceding vehicle 2 (140). Subsequent control is the same as described above.

When the controller 50 may not identify the preceding vehicle 2 while performing the virtual lane line following control (No in 151), the controller 50 determines whether the duration of the virtual lane line following control exceeds the predetermined control limit time (152).

When the duration of the virtual lane line following control exceeds the predetermined control limit time (Yes in 152), the controller 50 releases the traveling control of the vehicle.

When the duration of the virtual lane line following control does not exceed the predetermined control limit time (No in 152), the controller 50 continuously acquires the image data of the surroundings acquired by the camera 10 and the radar data of the surroundings acquired by the radars 20 and 30 (A) and continuously determines whether the lane lines LL and RL of the driving lane DL of the vehicle 1 are identified on the basis of the image data of the surroundings of the vehicle 1. Depending on the determination result, the controller 50 may maintain the virtual lane line following control or also change the virtual lane line following control to the lane line following control or the vehicle following control.

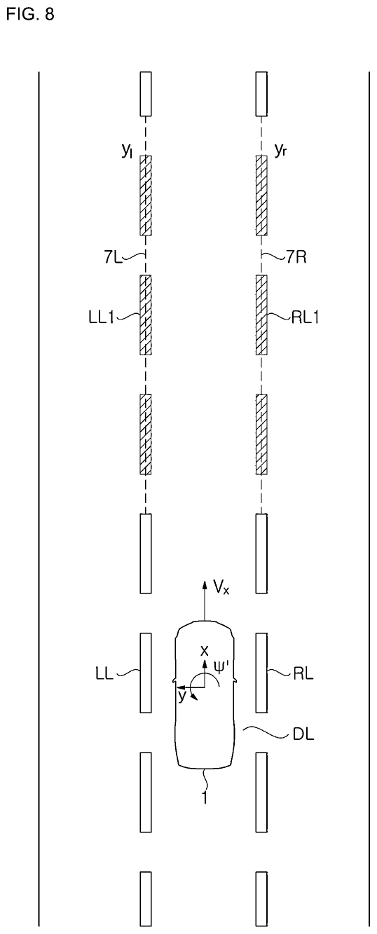

FIG. 8 is a view schematically showing a method of generating corrected lane lines of the driver assistance system according to the embodiment.

When performing the lane line following control, the controller 50 of the driver assistance system according to the present disclosure may follow corrected lane lines 7L and 7R generated on the basis of the positions of the left and right lane lines, heading angles of the left and right lane lines, curvatures of the left and right lane lines, and changes in the curvatures of the left and right lane lines when the identified lane lines LL and RL of the driving lane DL of the vehicle 1 are not suitable for following. In other words, the controller 50 may generate the corrected lane lines 7L and 7R, determine the target trajectory of the vehicle 1 on the basis of the corrected lane lines 7L and 7R, and control the traveling of the vehicle 1.

FIG. 8 shows the corrected lane lines 7L and 7R.

The left lane line LL and the right lane line RL are respectively present on the left and right of the driving lane DL on which the vehicle 1 travels. Some lane lines LL1 and RL1 of the left and right lane lines LL and RL are identified, but there may be a case in which the lane lines are not suitable for following. For example, there may be a case in which some lane lines LL1 and RL1 of the lane lines LL and RL are blurred and the positions of the lane lines are not clear, a case in which several lane lines overlap and thus the lane lines LL and RL, which is the following target, may not be identified, a case in which the lane lines LL and RL are incorrectly drawn and thus directions or curvatures thereof are not suitable for the traveling of the vehicle 1, or the like.

The controller 50 may generate the corrected lane lines 7L and 7R when the lane lines LL and RL are not suitable for following, determine the target trajectory of the vehicle 1 on the basis of the corrected lane lines 7L and 7R, and control the traveling of the vehicle 1.

The corrected lane lines 7L and 7R may be generated on the basis of Equations 1 and 2.

yₗ=αₗx³+bₗx²+cₗx+dₗ (Equation 1)

yᵣ=αᵣx³+bᵣx²+cᵣx+dᵣ (Equation 2)

(yₗ and yᵣ denote positions of the left and right corrected lane lines 7L and 7R at an x position, respectively, αₗ and αᵣ denote the changes in the curvatures of the left and right lane lines LL and RL, respectively, bₗ and bᵣ denote the curvatures of the left and right lane lines LL and RL, respectively, cₗ and cᵣ denote the heading angles of the left and right lane lines LL and RL, respectively, and dₗ and dᵣ denote the positions of the left and right lane lines LL and RL, respectively).

Equation 1 is an equation representing a width directional position (yₗ) of the left corrected lane line 7L according to a traveling direction position (x), and Equation 2 is an equation representing a width directional position (yᵣ) of the right corrected lane line 7R according to the traveling direction position (x).

As in Equations 1 and 2, the controller 50 may generate the corrected lane lines 7L and 7R on the basis of the positions, heading angles, curvatures, and changes in the curvatures of the left and right lane lines LL and RL that may be identified.

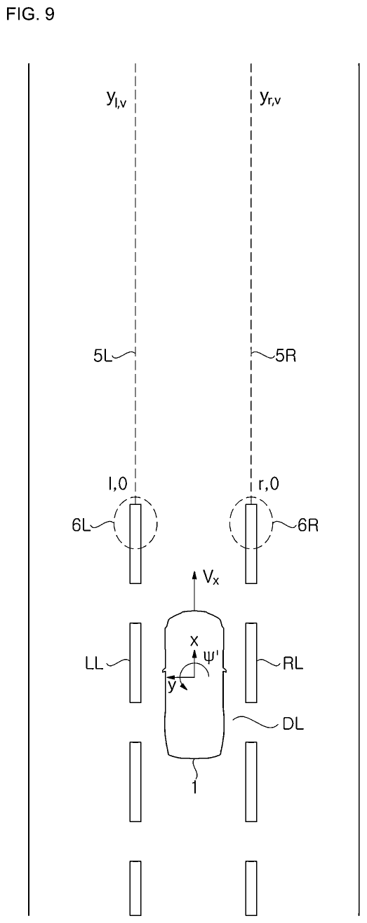

FIG. 9 is a view schematically showing a method of generating virtual lane lines of the driver assistance system according to the embodiment.

The controller 50 of the driver assistance system according to the present disclosure may generate the virtual driving lane lines 5L and 5R on the basis of the positions of the last identified left and right lane lines, the heading angles of the left and right lane lines, the curvatures of the left and right lane lines, the yaw rate of the vehicle 1, and the vehicle speed of the vehicle 1 when performing the virtual lane line following control. The controller 50 may determine the target trajectory of the vehicle 1 on the basis of the generated virtual driving lane lines 5L and 5R and control the traveling of the vehicle 1.

FIG. 9 shows the virtual driving lane lines 5L and 5R.

The left lane line LL and the right lane line RL are respectively present on the left and right of the driving lane DL on which the vehicle 1 travels. When the left and right lane lines LL and RL may not be identified according to the traveling of the vehicle 1, the controller 50 may generate the virtual driving lane lines 5L and 5R, determines the target trajectory of the vehicle 1 on the basis of the virtual driving lane lines 5L and 5R, and control the traveling of the vehicle 1.

The driver assistance system in which the virtual driving lane lines 5L and 5R are generated on the basis of Equations 3 and 4 is provided.

y_{l,v}=b_{l,0}x²+(c_{l,0}−∫ωΨ′)x+d_{l,0}+∫∫vₓΨ′ (Equation 3)

y_{r,v}=b_{r,0}x²+(c_{r,0}−∫Ψ′)x+d_{r,0}+∫∫vₓΨ′ (Equation 4)

(y_{l,v} and y_{r,v} denote positions of the left and right virtual driving lane lines at the x position, respectively, b_{l,0} and b_{r,0} denote the curvatures of the last identified left and right lane lines, respectively, c_{l,0} and c_{r,0} denote the heading angles of the last identified left and right lane lines, respectively, d_{l,0} and d_{r,0} denote the positions of the last identified left and right lane lines, respectively, P denotes the yaw rate of the vehicle, and vₓ, denotes the vehicle speed of the vehicle).

Equation 3 is an equation representing a width directional position (y_{l,v}) of the left virtual driving lane line 5L according to a traveling direction position ((x), and Equation 4 is an equation representing a width directional position (y_{r,v}) of the right virtual driving lane line 5R according to the traveling direction position (x).

The controller 50 may generate the virtual driving lane lines 5L and 5R on the basis of the vehicle speed and the yaw rate of the vehicle 1 in addition to positions (l,0) (r,0), heading angles, and curvatures of last identified left and right lane lines 6L and 6R.

As is apparent from the above description, a driver assistance system and a driver assistance method according to the disclosed embodiments can select and perform lane line following control, vehicle following control, or virtual lane line following control depending on whether lane lines are identified or a preceding vehicle is identified, thereby continuously maintaining traveling control of a vehicle without stopping the control even when surrounding environments are changed.

The driver assistance system and the driver assistance method according to the disclosed embodiments can set a control priority in the lane line following control, the vehicle following control, or the virtual lane line following control and perform accurate traveling control of the vehicle.

The driver assistance system and the driver assistance method according to the disclosed embodiments can generate virtual lane lines and follow the virtual lane lines even when lane lines cannot be identified and a preceding vehicle is not present and perform the traveling control of the vehicle.

The driver assistance system and the driver assistance method according to the disclosed embodiments can achieve the safety of the vehicle by terminating the traveling control of the vehicle when a control release condition occurs under the vehicle following control or the virtual lane line following control.

As described above, the disclosed embodiments have been described with reference to the accompanying drawings. Those skilled in the art to which the present disclosure pertains will understand that the present disclosure can be practiced in a form different from the disclosed embodiments even without changing the technical spirit or essential features of the present disclosure. The disclosed embodiments are illustrative and should not be construed as limiting.

What is claimed is:

1. A driver assistance system comprising:
a camera configured to acquire image data of surroundings of a vehicle with a field of view around the vehicle;
a radar configured to acquire radar data of the surroundings of the vehicle with a field of sensing around the vehicle; and
a controller electrically connected to the camera and the radar to perform traveling control of the vehicle,
wherein the controller is configured to:
determine whether a lane line of a driving lane of the vehicle is identified or whether a preceding vehicle positioned in front of the vehicle is identified on the basis of the image data of the surroundings of the vehicle or the radar data of the surroundings of the vehicle;
depending on a result of the determination, select and perform traveling control of any one of lane line following control of following the identified lane line, vehicle following control of following the identified preceding vehicle, and virtual lane line following control of generating a virtual driving lane line and following the generated virtual driving lane line; and
release the traveling control of the vehicle on the basis of an operating time of the virtual lane line following control exceeding a predetermined control limit time while the virtual lane line following control is performed.

2. The driver assistance system of claim 1, wherein the controller is configured to:
based on the lane line of the driving lane being identifiable on the basis of the image data of the surroundings of the vehicle, perform the lane line following control of determining a target trajectory of the vehicle on the basis of the lane line and controlling the vehicle to travel;
based on the lane line being not identifiable, perform the vehicle following control of identifying the preceding vehicle positioned in front of the vehicle on the basis of the radar data of the surroundings of the vehicle, determining a target trajectory of the vehicle on the basis of a traveling route of the preceding vehicle, and controlling the vehicle to travel; and
based on the preceding vehicle being not identifiable, perform the virtual lane line following control of generating the virtual driving lane line on the basis of a lane line of a last identified driving lane, determining a target trajectory of the vehicle on the basis of the virtual driving lane line, and controlling the vehicle to travel.

3. The driver assistance system of claim 2, wherein the controller is configured to:
check whether the lane line of the driving lane of the vehicle is identifiable on the basis of the image data of the surroundings of the vehicle while the vehicle following control or the virtual lane line following control is performed; and
based on the lane line being identifiable, terminate the vehicle following control or the virtual lane line following control being performed, and perform the lane line following control.

4. The driver assistance system of claim 2, wherein the controller releases the traveling control of the vehicle on the basis of the preceding vehicle being not identifiable in front of the vehicle while the vehicle following control is performed.

5. The driver assistance system of claim 2, wherein the controller checks whether the preceding vehicle positioned in front of the vehicle is identifiable while the virtual lane line following control is performed, and based on the preceding vehicle being identifiable, terminates the virtual lane line following control being performed, and performs the vehicle following control.

6. The driver assistance system of claim 1, wherein the controller follows corrected lane lines generated on the basis of positions of left and right lane lines, heading angles of the left and right lane lines, curvatures of the left and right lane lines, and changes in the curvatures of the left and right lane lines on the basis of the identified lane line of the driving lane of the vehicle being not suitable for following when the lane line following control is performed.

7. The driver assistance system of claim 6, wherein the corrected lane lines are generated on the basis of Equations 1 and 2,
yₗ=αₗx³+bₗx²+cₗx+dₗ (Equation 1)
yᵣ=αᵣx³+bᵣx²+cᵣx+dᵣ (Equation 2)
(yₗ and yᵣ denote positions of the left and right corrected lane lines at an x position, respectively, αₗ and αᵣ denote the changes in the curvatures of the left and right lane lines, respectively, bₗ and bᵣ denote the curvatures of the left and right lane lines, respectively, cₗ and cᵣ denote the heading angles of the left and right lane lines, respectively, and dₗ and dᵣ denote the positions of the left and right lane lines, respectively).

8. The driver assistance system of claim 1, wherein the controller generates the virtual driving lane line on the basis of positions of last identified left and right lane lines, heading angles of the left and right lane lines, curvatures of the left and right lane lines, a yaw rate of the vehicle, and a vehicle speed of the vehicle when the virtual lane line following control is performed.

9. The driver assistance system of claim 8, wherein the virtual driving lane line is generated on the basis of Equations 3 and 4,
y_{l,v}=b_{l,0}x²+(c_{l,0}−∫ωΨ′)x+d_{l,0}+∫∫vₓΨ′ (Equation 3)
y_{r,v}=b_{r,0}x²+(c_{r,0}−∫Ψ′)x+d_{r,0}+∫∫vₓΨ′ (Equation 4)
(y_{l,v} and y_{r,v} denote positions of the left and right virtual driving lane lines at an x position, respectively, b_{l,0} and b_{r,0} denote the curvatures of the last identified left and right lane lines, respectively, c_{l,0} and c_{r,0} denote the heading angles of the last identified left and right lane lines, respectively, d_{l,0} and d_{r,0} denote the positions of the last identified left and right lane lines, respectively, Ψ denotes the yaw rate of the vehicle, and vₓ denotes the vehicle speed of the vehicle).

10. A driver assistance method comprising:
acquiring image data of surroundings of a vehicle or radar data of the surroundings;
determining whether a lane line of a driving lane of the vehicle is identified or whether a preceding vehicle positioned in front of the vehicle is identified on the basis of the acquired image data of the surroundings or the acquired radar data of the surroundings; and
depending on a result of the determination, selecting and performing traveling control of any one of lane line following control of following the identified lane line, vehicle following control of following the identified preceding vehicle, and virtual lane line following control of generating a virtual driving lane line and following the generated virtual driving lane line,
wherein the performing of the virtual lane line following control includes releasing the traveling control of the vehicle on the basis of an operating time of the virtual lane line following control exceeding a predetermined control limit time while the virtual lane line following control is performed.

11. The driver assistance method of claim 10, wherein the selecting and performing of the traveling control includes:
based on the lane line of the driving lane being identifiable on the basis of the image data of the surroundings of the vehicle, performing the lane line following control of determining a target trajectory of the vehicle on the basis of the lane line and controlling the vehicle to travel;
based on the lane line being not identifiable, performing the vehicle following control of identifying the preceding vehicle positioned in front of the vehicle on the basis of the radar data of the surroundings of the vehicle, determining a target trajectory of the vehicle on the basis of a traveling route of the preceding vehicle, and controlling the vehicle to travel; and
based on the preceding vehicle being not identifiable, performing the virtual lane line following control of generating the virtual driving lane line on the basis of a last identified lane line of the driving lane, determining a target trajectory of the vehicle on the basis of the virtual driving lane line, and controlling the vehicle to travel.

12. The driver assistance method of claim 11, wherein the performing of the vehicle following control or the performing of the virtual lane line following control includes checking whether the lane line of the driving lane of the vehicle is identifiable on the basis of the image data of the surroundings of the vehicle while the vehicle following control or the virtual lane line following control is performed, and based on the lane line being identifiable, terminating the vehicle following control or the virtual lane line following control being performed and performing the lane line following control.

13. The driver assistance method of claim 11, wherein the performing of the vehicle following control includes releasing the traveling control of the vehicle on the basis of the preceding vehicle being not identifiable in front of the vehicle while the vehicle following control is performed.

14. The driver assistance method of claim 11, wherein the performing of the virtual lane line following control includes checking whether the preceding vehicle positioned in front of the vehicle is identifiable while the virtual lane line following control is performed, and based on the preceding vehicle being identifiable, terminating the virtual lane line following control being performed and performing the vehicle following control.

15. The driver assistance method of claim 10, wherein the performing the lane line following control includes following corrected lane lines generated on the basis of positions of left and right lane lines, heading angles of the left and right lane lines, curvatures of the left and right lane lines, and changes in the curvatures of the left and right lane lines on the basis of the identified lane line of the driving lane of the vehicle being not suitable for following when the lane line following control is performed.

16. The driver assistance method of claim 15, wherein the corrected lane lines are generated on the basis of Equations 1 and 2,
yₗ=αₗx³+bₗx²+cₗx+dₗ (Equation 1)
yᵣ=αᵣx³+bᵣx²+cᵣx+dᵣ (Equation 2)
(yₗ and yᵣ denote positions of the left and right corrected lane lines at an x position, respectively, αₗ and αᵣ denote the changes in the curvatures of the left and right lane lines, respectively, bₗ and bᵣ denote the curvatures of the left and right lane lines, respectively, cₗ and cᵣ denote the heading angles of the left and right lane lines, respectively, and dₗ and dᵣ denote the positions of the left and right lane lines, respectively).

17. The driver assistance method of claim 10, wherein the performing of the virtual lane line following control includes generating the virtual driving lane line on the basis of positions of last identified left and right lane lines, heading angles of the left and right lane lines, curvatures of the left and right lane lines, a yaw rate of the vehicle, and a vehicle speed of the vehicle when the virtual lane line following control is performed.

18. The driver assistance method of claim 17, wherein the virtual driving lane line is generated on the basis of Equations 3 and 4,
y_{l,v}=b_{l,0}x²+(c_{l,0}−∫ωΨ′)x+d_{l,0}+∫∫vₓΨ′ (Equation 3)
y_{r,v}=b_{r,0}x²+(c_{r,0}−∫Ψ′)x+d_{r,0}+∫∫vₓΨ′ (Equation 4)
(y_{l,v} and y_{r,v} denote positions of the left and right virtual driving lane lines at an x position, respectively, b_{l,0} and b_{r,0} denote the curvatures of the last identified left and right lane lines, respectively, c_{l,0} and c_{r,0} denote the heading angles of the last identified left and right lane lines, respectively, d_{l,0} and d_{r,0} denote the positions of the last identified left and right lane lines, respectively, Ψ denotes the yaw rate of the vehicle, and vₓ denotes the vehicle speed of the vehicle).
